(19) United States
(12) Patent Application Publication
(10) Pub. No.: US 2011/0242417 A1
(43) Pub. Date: Oct. 6, 2011

(54) IMAGE PROCESSING APPARATUS

(76) Inventors: Kanako SAITO, Tokyo (JP); Toshiyuki Ono, Kanagawa-ken (JP); Toshimitsu Kaneko, Kanagawa-ken (JP)

(21) Appl. No.: 12/878,279

(22) Filed: Sep. 9, 2010

(30) Foreign Application Priority Data
Mar. 30, 2010 (JP) P2010-079819

(51) Int. Cl. H04N 5/14

(52) U.S. Cl. 348/576; 348/E05.062

(57) ABSTRACT

An image processing device includes an acquisition unit, a memory, a search unit, and a synthesis unit. The acquisition unit acquires a moving image including a plurality of images, and sets a pixel in a process image as a target pixel. The process image is to be processed in the moving image. The memory stores a fine texture image obtained by extracting a texture component in a reference image different from the process image. The search unit sets a pixel position of the target pixel as a first position, and to search a predetermined range in the fine texture image in order to find a second position corresponding to the first position. The synthesis unit synthesizes a pixel value of the second position in the fine texture image with a pixel value of the target pixel.

### CROSS-REFERENCE TO RELATED APPLICATION

This application is based upon and claims the benefit of priority from Japanese Patent Application No. 2010-079819, filed on Mar. 30, 2010, the entire contents of which are incorporated herein by reference.

### FIELD

Embodiments described herein relate generally to an image processing apparatus.

### BACKGROUND

Digital TV broadcasting realizes higher resolutions and higher image quality compared with analog TV broadcasting. In order to further improve the image quality, improvement of fineness is important.

One of the techniques to improve the fineness is disclosed in JP-A 2008-310117 (KOKAI).

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram of an image processing device 1 included in a first embodiment;

FIG. 2 is a block diagram of an image processing device 2 included in the first embodiment;

FIG. 3 is a flowchart explaining an operation of the first embodiment;

FIG. 4 is a block diagram of the generation unit in the image processing device 2;

FIG. 5A shows an example of the image before extraction;

FIG. 5B shows a non-texture component using the Center/Surround Retinex method;

FIG. 5C shows the texture component using the Center/Surround Retinex method;

FIG. 5D shows a non-texture component using the skeleton-texture separation method;

FIG. 5E shows the texture component using the skeleton-texture separation method;

FIG. 6 is a diagram explaining a relationship between the texture image and the fine texture image;

FIG. 7 is a diagram explaining the method to generate the fine texture image;

FIG. 8 is diagram explaining the method to generate the fine texture image;

FIG. 9 is a flow chart explaining operation for calculating a motion vector;

FIG. 10 is a figure explaining how the sub pixel estimation is performed by using the equiangular linear fitting;

FIG. 11 is a figure explaining how the sub pixel estimation is performed by using the parabola fitting;

FIG. 12 is a block diagram of an image processing device according to the second embodiment;

FIG. 13 is a flow chart explaining operation of the image processing device;

FIG. 14 is a block diagram of an image processing device according to the modified example; and

FIG. 15 is a flow chart explaining operation of the image processing device.

### DETAILED DESCRIPTION

According to one aspect of the invention, an image processing apparatus, includes an acquisition unit to acquire a moving image including a plurality of images, and to set a pixel in a process image as a target pixel, the process image being to be processed in the moving image; a memory to store a fine texture image obtained by extracting a texture component in a reference image different from the process image; a search unit to set a pixel position of the target pixel as a first position, and to search a predetermined range in the fine texture image in order to find a second position corresponding to the first position; and a synthesis unit to synthesize a pixel value of the second position in the fine texture image with a pixel value of the target pixel.

In the embodiments, an image processing apparatus converts moving image data which may be photographed by a video camera or received by a television set, into moving image data having higher image quality. The image processing apparatus according to the embodiments will be described below with reference to the drawings.

### Description of the First Embodiment

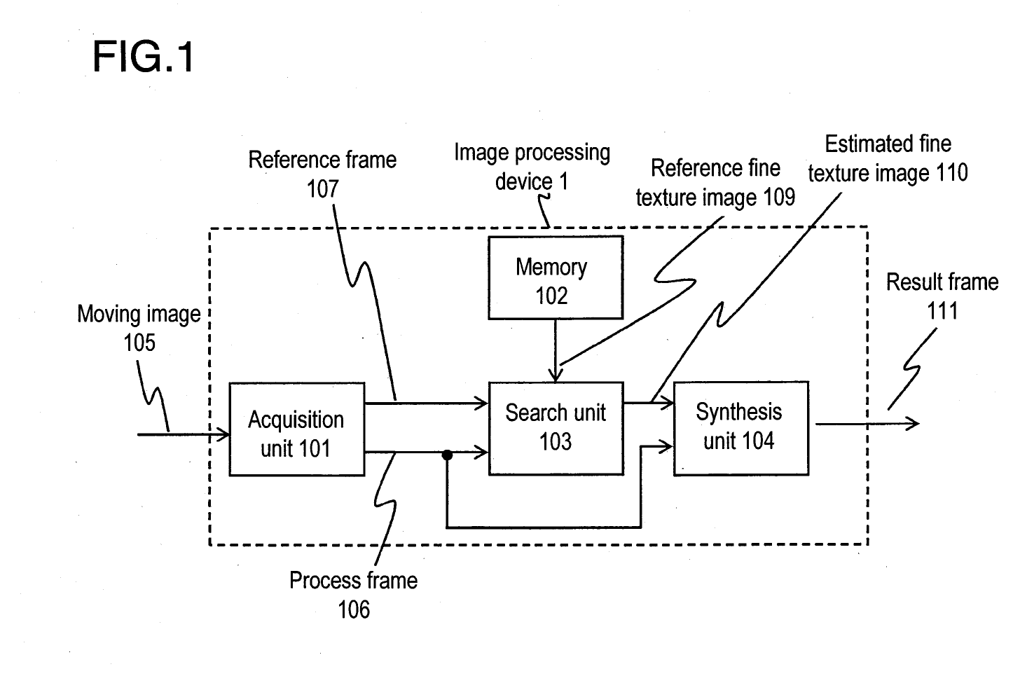

FIG. 1 is a block diagram of an image processing device 1 included in a first embodiment. The image processing device 1 includes an acquisition unit 101, a memory 102, a search unit 103 and a synthesis unit 104. The image processing device 1 may further include a display unit to display a synthesis result from the synthesis unit 104.

The image processing device 1 receives a moving image 105 including multiple images (hereinafter, an image is referred to as “a frame”). The multiple images are subjected to a quality improvement process and a flicker prevention process to obtain a result frame 111. After these processes, the image processing device 1 outputs the result frame 111.

The moving image 105 is firstly inputted into the acquisition unit 101. The acquisition unit 101 sets an image in the moving image 105 as a process frame 106. The acquisition unit 101 also selects and reads a reference frame 107 that is a frame different from the process frame 106. Furthermore, the acquisition unit 101 sets a pixel in the process frame 106 as a target pixel.

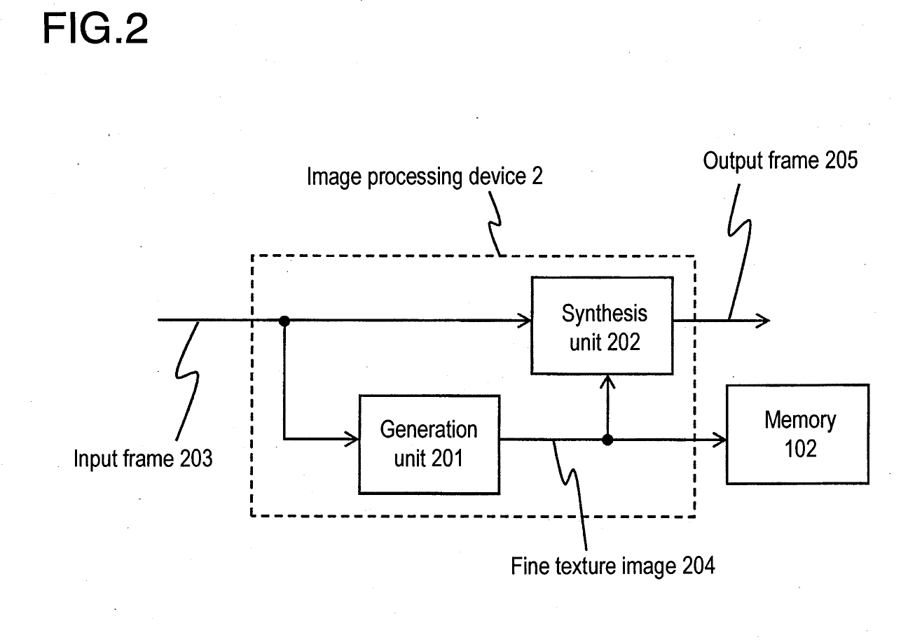

FIG. 2 is a block diagram of an image processing device 2 included in the first embodiment. The image processing device 2 generates a fine texture image for the image processing device 1. As shown in FIG. 2, the image processing device 2 includes a generation unit 201 and a synthesis unit 202. The generation unit 201 receives the reference frame 107 as an input frame 203 from the acquisition unit 101 of the image processing device 1. The generation unit 201 generates a fine texture image 204 from the input frame 203. The fine texture image 204 is a fine texture component obtained by increasing a space frequency of a texture component included in the input frame 203. The synthesis unit 202 synthesizes the input frame 203 with the fine texture image 204 to obtain an output frame 205. The generation unit 201 also outputs the fine texture image 204 to the memory 102. That is, the memory 102 stores the fine texture image 204. The image processing device 1 reads the fine texture image 204 as a reference fine texture image 109 from the memory 102 and uses the reference fine texture image 109 for the quality improvement process and the flicker prevention process, and the process frame 106 is treated as the reference frame 107.

The search unit 103 calculates a change amount from the process frame 106 and the reference frame 107. The change amount indicates changes of pixels or regions. Then, the search unit 103 generates an estimated fine texture image 110 based on the reference fine texture image 109 and the change amount. The estimated fine texture image 110 is a fine texture component to be applying to the process frame 106 at the synthesis unit 104. The search unit 103 outputs the estimated fine texture image 110 to the synthesis unit 104.

The synthesis unit 104 synthesizes the process frame 106 with the estimated fine texture image 110 to obtain the result frame 111.

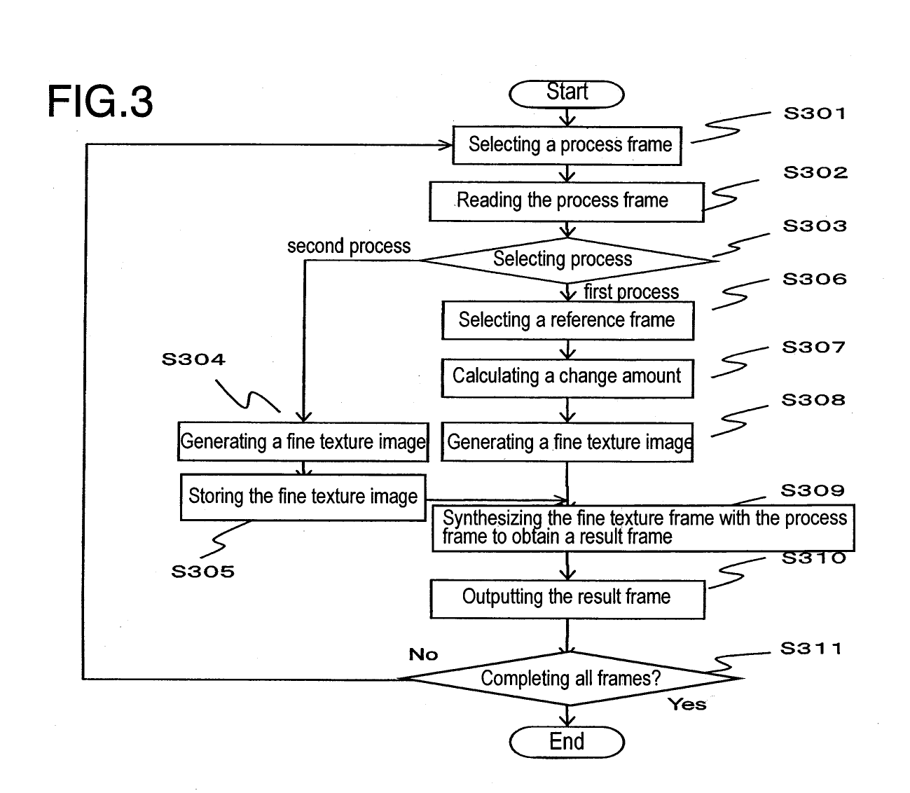

Next, a detailed operation of the first embodiment will be described. FIG. 3 is a flowchart explaining an operation of the first embodiment, using the image processing device 1 or the image processing device 2.

At the step S301, a process frame 106 is selected from the moving image 105. The process frame 106 may be any one of unprocessed frames in the moving image 105.

At the step S302, the acquisition unit 101 reads the process frame 106 as an image data.

At the step S303, the first process or the second process is selected to be applied for the process frame 106. The first process is performed by the image processing device 1. The second process is performed by the image processing device 2. The first or second process is selected due to whether or not a new fine texture image needs to be generated. If the new fine texture image is going to be generated, the second process is selected and the process frame 106 is treated as the reference frame 107. On the other hand, the reference fine texture image 109 is already stored in the memory 102, the first process may be selected. For example, if the number of the frames existing between the process frame 106 and the reference frame 107 is within the range of a certain number, the first process is selected. Preferably, the first or second process is better to be selected according to the change amount. It is possible to further prevent a flicker on the image.

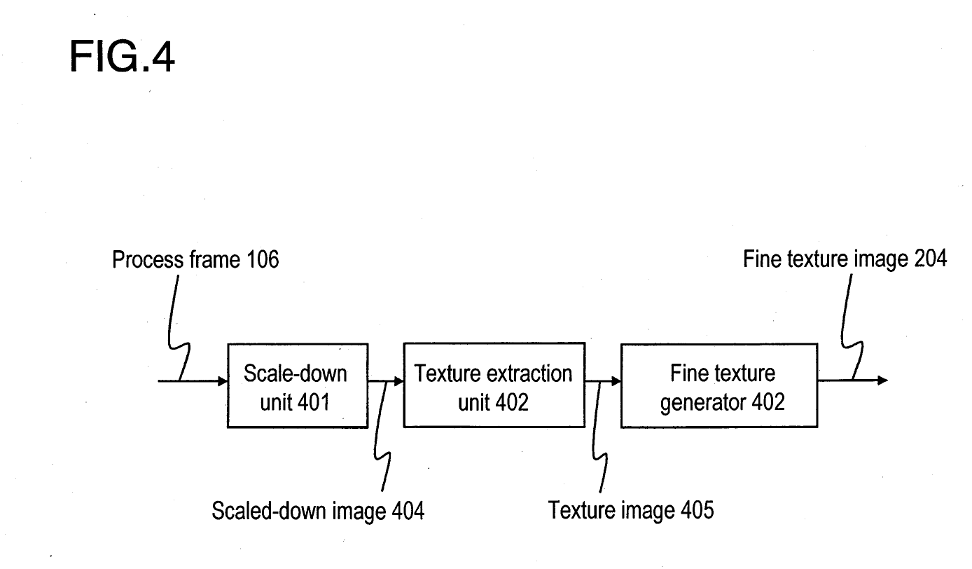

At the step S304, the generation unit 201 of the image processing device 2 generates the fine texture image 204 from the reference frame 107 when the second process is selected. FIG. 4 is a block diagram of the generation unit 201 in the image processing device 2. The generation unit 201 includes a scale-down unit 401, a texture extraction unit 402, and a fine texture generator 403. The scale-down unit 401 scales down the reference frame 107 to obtain a scaled-down image 404.

For example, in an image including one original texture pattern, a new texture pattern whose frequency is K times as large as the original texture pattern can be generated by multiplying the image by 1/K times. Here, K is a real number within the range of 0<K<1.0. The texture extraction unit 402 generates a texture image 405 indicating minute vibration on the surface of a photographed subject, from the scaled-down image 404. The texture image 405 can be generated by using a texture extraction method, such as a skeleton-texture separation method, a Center/Surround Retinex method, or ε-filter, for example.

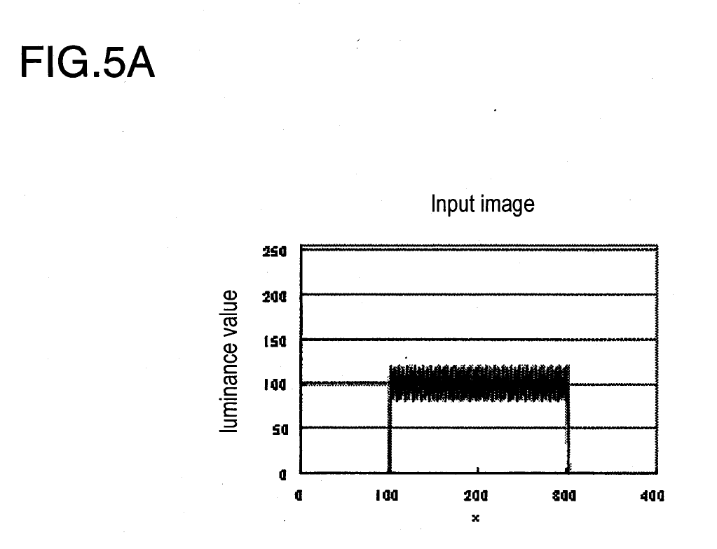

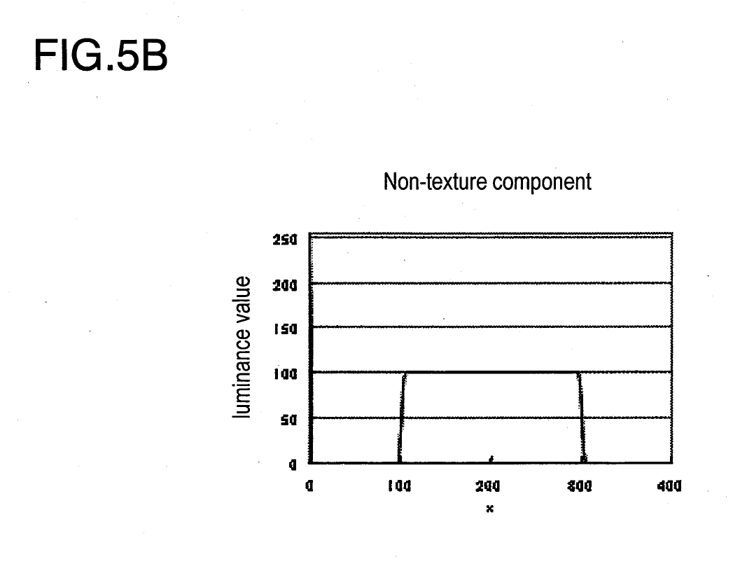

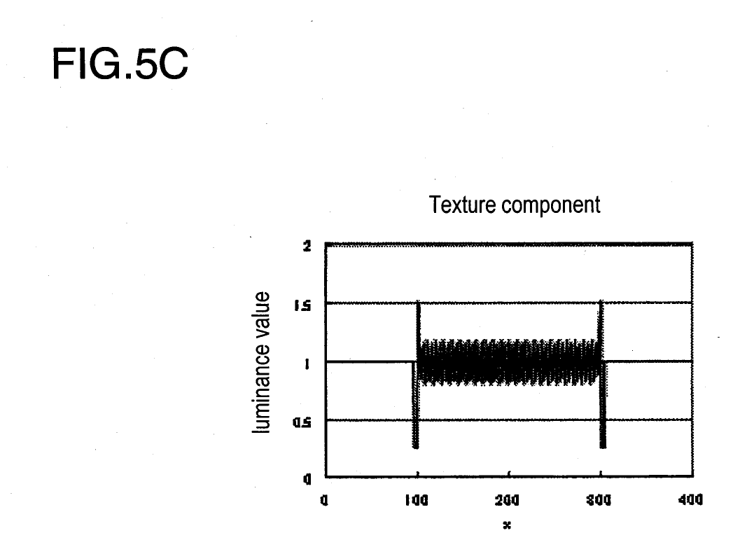

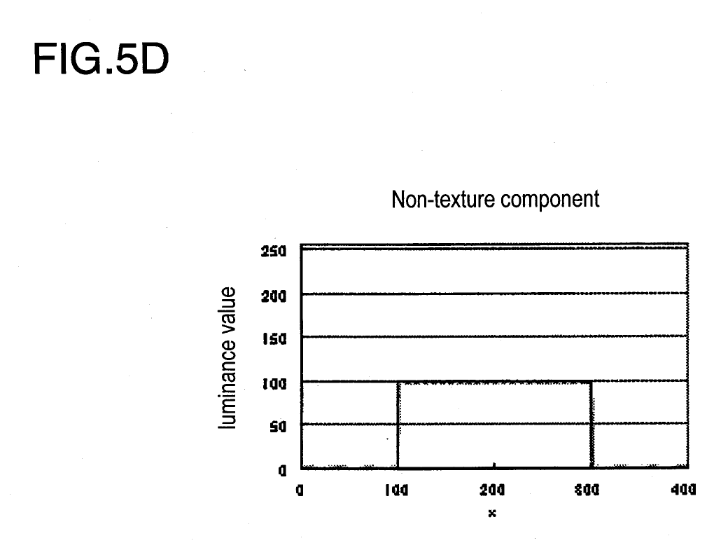

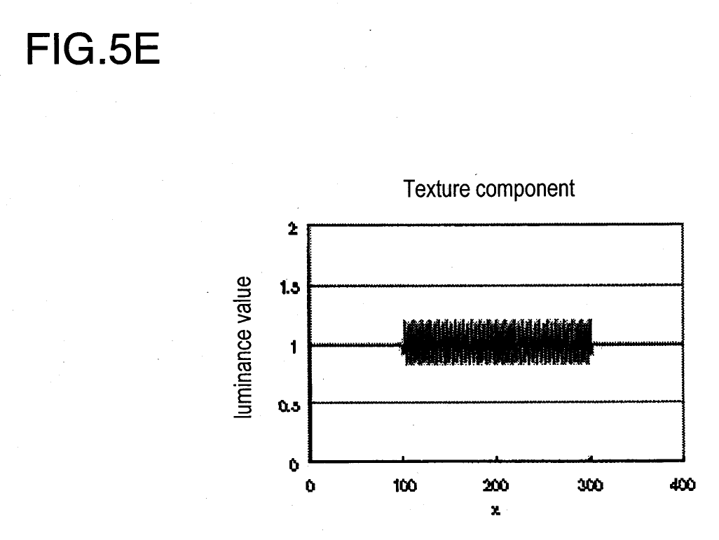

FIGS. 5A to 5E are graphs for explaining method of extracting a texture component from an image. FIGS. 5A to 5E are cases where the image is considered based on one dimension. The horizontal axis shows coordinate, and the vertical axis shows a luminance value at the coordinate. FIG. 5A shows an example of the image before extraction. FIGS. 5B and 5C are non-texture and texture components, which are separated from the image shown in FIG. 5A by using the Center/Surround Retinex method. FIG. 5B shows a non-texture component. FIG. 5C shows the texture component. When the Center/Surround Retinex method is applied, the texture component has a high-level edge. FIGS. 5D and 5E are non-texture and texture components, which are separated from the image shown in FIG. 5A by using the skeleton-texture separation method. FIG. 5D shows a non-texture component. FIG. 5E shows the texture component. When the skeleton-texture separation method is applied, the non-texture component has an edge having a large luminance difference. Any of the methods can remove a rough change pattern of the luminance from the image shown in FIG. 5A, and obtain the texture component.

The fine texture generator 403 generates the fine texture image 204 from the texture image 405. The fine texture image 204 is generated by searching a region neighboring a position in the texture image 405 corresponding to a position in the fine texture image 204. The searching is performed for each region where the fine texture image 204 is generated. Specifically, the fine texture image 204 is generated in the following procedure. (a) Selecting a pixel, whose pixel value in the fine texture image 204 is not obtained yet, as a processed pixel. (b) Setting a region neighboring the position in the texture image 405 corresponding to the position of the processed pixel in the fine texture image 204, as a search range. (c) Assigning a pixel value of a pixel, which is neighboring the processed pixel in the search range and similar to a change pattern of the pixel value, to a pixel value of the processed pixel. The change pattern is obtained from the pixel values of the neighboring pixels.

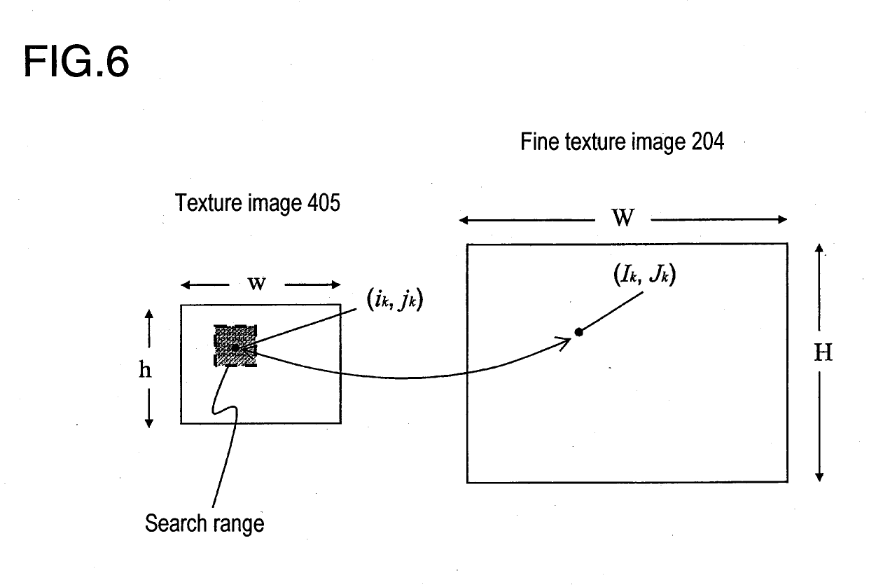

FIG. 6 is a diagram explaining a relationship between the texture image 405 and the fine texture image 204. When a size of the texture image 405 is set as w×h [pixels] and an image size of the fine texture image 204 is set as W×H [pixels], if a generation region of a fine texture image is represented by coordinates (Iₖ, Jₖ), coordinates (iₖ, jₖ) corresponding to the generation region in the texture image 405 are obtained by equations (1).

$${i}_{k} = {I}_{k} \times \frac{w}{W} , {j}_{k} = {J}_{k} \times \frac{h}{H} \qquad ( 1 )$$

The search range is a region surrounding the point of the coordinates (iₖ, jₖ) in the texture image 405. The search range is set as a small region of about from 10×10 [pixels] to 40×40 [pixels].

When the texture image 405 is scaled up to the fine texture image 204 having higher resolution, if a simple scale-up process, such as a generally used bilinear interpolation method or a bicubic interpolation method is applied, high frequency texture component is lost. Accordingly, a high-resolution image is difficult to be obtained. In the first embodiment, a texture synthesis method is applied to generate the fine texture image 204 from the texture image 405. The texture synthesis method has been proposed in a field of a CG (computer graphics), and will be described below in detail.

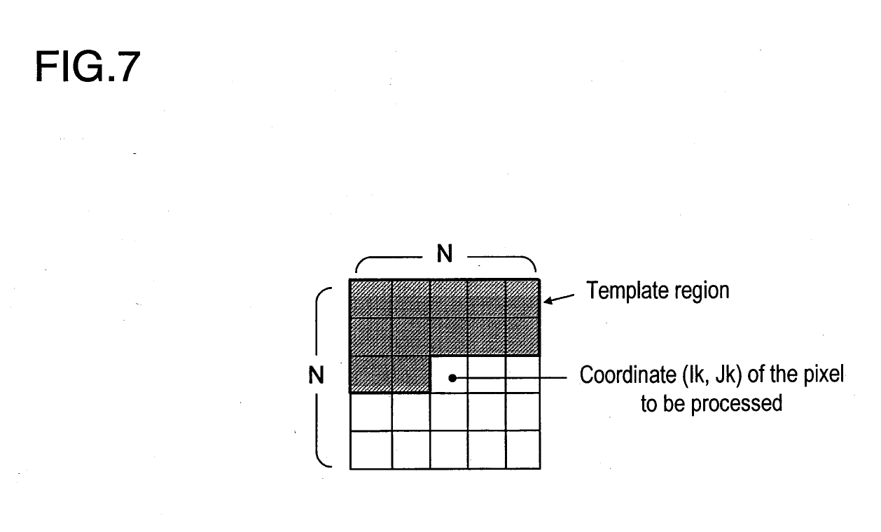

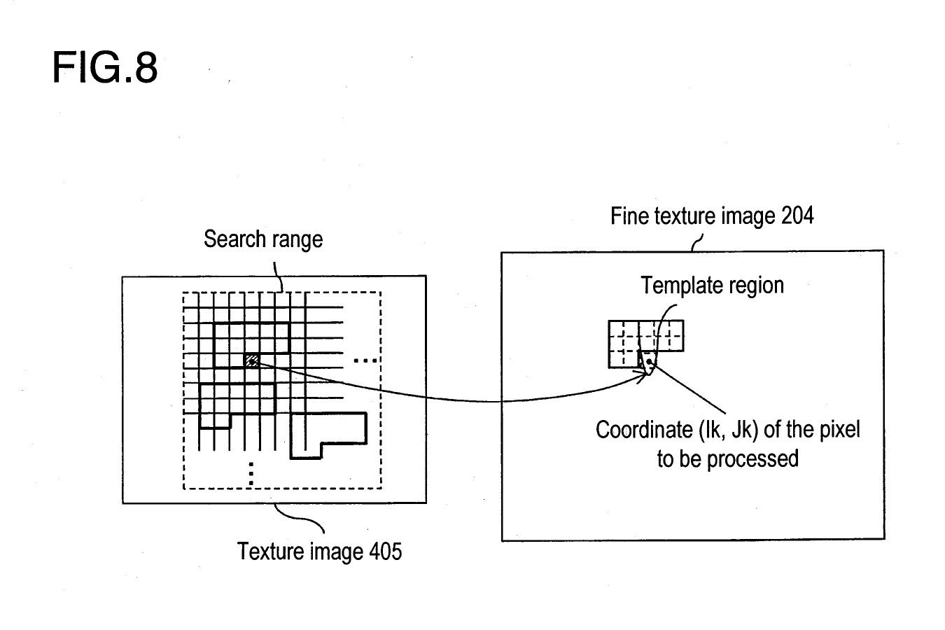

FIG. 7 and FIG. 8 are diagrams explaining the method to generate the fine texture image 204.

The coordinates (Ik, Jk) of the pixel to be processed are serially moved from the upper left side to the lower right side. As shown in FIG. 7, a template region is a region including the pixels whose pixel values are already assigned, in the adjacent regions (size N×N [pixels]) surrounding the coordinates (Ik, Jk).

As shown in FIG. 8, searching is performed in a region having the most similar change pattern of the pixel value to the template region. A luminance value of a pixel (diagonally shaded pixel in FIG. 8) corresponding the coordinates (Ik, Jk) in the template region is assigned to a luminance value of the coordinates (Ik, Jk) in the fine texture image 204. For example, when the searching is performed in a region that is most similar to the template region, a region having the minimum sums of squares of an error in each pixel in the region may be selected.

Referring back to FIG. 3, the fine texture image 204 generated at the step S304 is stored in the memory 102 at the step S305.

The reference frame 107 is selected at the step S306 when first process is selected at the step S303. The reference frame 107 is selected among the generation source frames of the fine texture image stored in the memory 102.

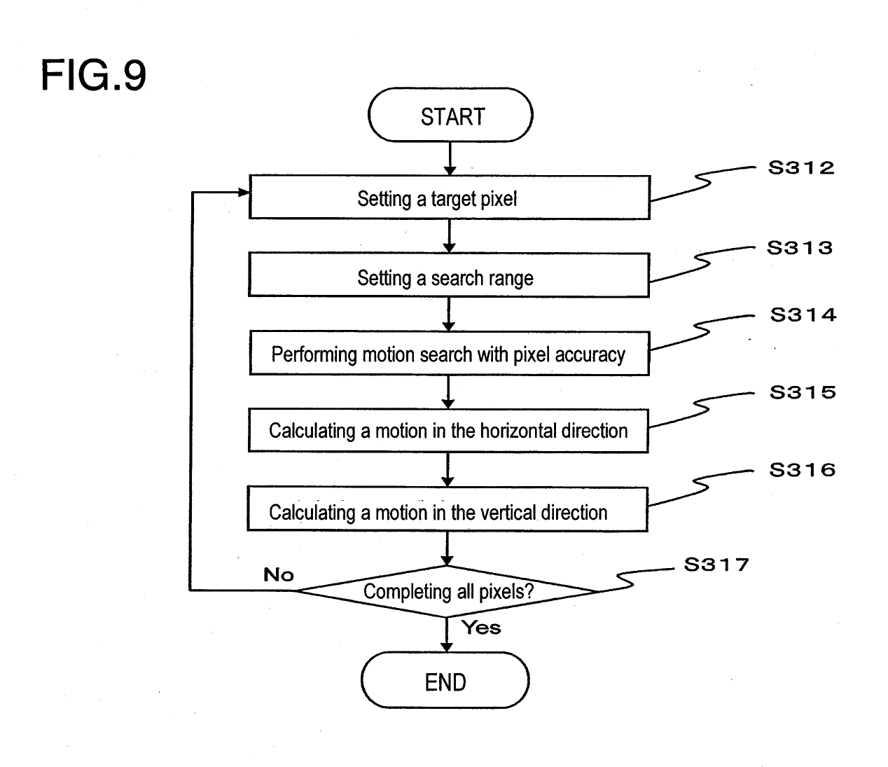

A change amount (hereinafter, referred to “motion vector”) from the process frame 106 to the reference frame 107 is calculated at the step S307. The motion vector may be calculated based on pixel accuracy, or based on accuracy (sub-pixel accuracy) finer than the one-pixel-basis accuracy. A method of calculating a motion vector based on the sub-pixel accuracy will be described with reference to a flowchart in FIG. 9.

Firstly, one pixel in the process frame 106 is set as a target pixel P at the step S312.

At the step S313, a motion search range is set in the reference frame 107. A center of the motion search range is set at a position corresponding to the target pixel P in the process frame 106. The motion search range is a rectangular block, for example.

At the step S314, difference between two pixel value patterns is calculated. One pixel value pattern is obtained in a block having a pixel within the search range as the center. The other pixel value pattern is obtained in a block having the target pixel as the center. Hereinafter, the difference is called as a matching error of between the center pixels of the respective blocks. A sum of absolute differences (SAD) value is used as the matching error in the first embodiment. However, a sum of squared differences (SSD) value can be also used. A block with a larger matching error has a larger difference in pixel value pattern from the block having the target pixel as the center. A matching error is calculated for pixels in the search range, and a pixel having the lowest matching error in the search range is determined as a pixel indicated by the motion vector based on the pixel accuracy. In this case, all pixels within the search range may be searched, or alternatively, high speed searching can be achieved by using a diamond search. When the motion vector is calculated based on the pixel accuracy, the process progresses to the step S317 after the process at the step S314 is completed. When the motion vector is calculated based on the sub-pixel accuracy, the process progresses to the step S315.

Next, a motion with the sub-pixel accuracy is calculated by the following method using the motion vector with the pixel accuracy. Firstly, a motion in the horizontal direction is calculated at the step S315. Coordinates of the pixel indicated by the motion vector with the pixel accuracy may be set as (x, y). Accordingly, a motion vector x_{sub} with the sub-pixel accuracy in the horizontal direction of the image may be obtained by using the following equation (2) with a certain method which is called equiangular linear fitting, with an SAD value in the coordinates (i, j) set as an SAD (i, j).

$${x}_{sub} = \{ \begin{matrix}\frac{SAD ( x + 1 , y ) - SAD ( x - 1 , y )}{2 ( SAD ( x , y ) - SAD ( x - 1 , y ) )} & if SAD ( x + 1 , y ) < SAD ( x - 1 , y ) \\ \frac{SAD ( x + 1 , y ) - SAD ( x - 1 , y )}{2 ( SAD ( x , y ) - SAD ( x + 1 , y ) )} & otherwise\end{matrix} \qquad ( 2 )$$

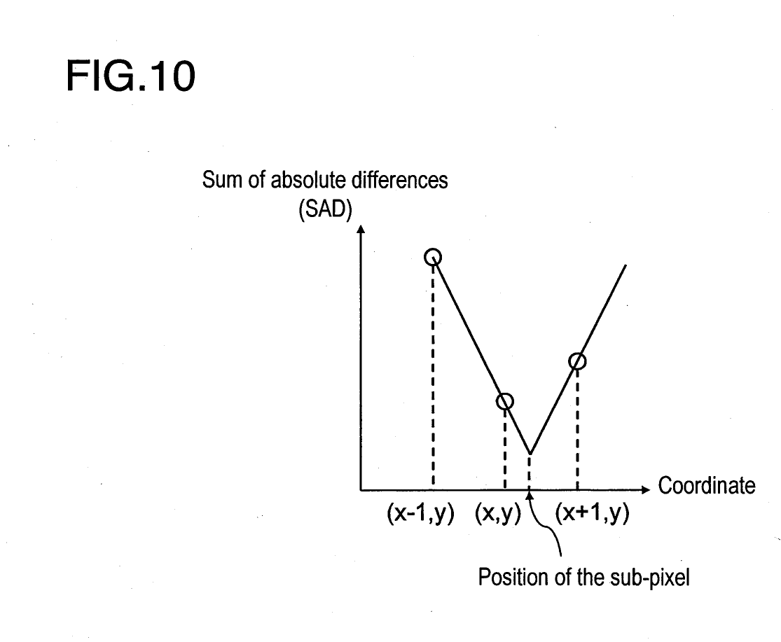

FIG. 10 is a figure explaining how the sub pixel estimation is performed by using the equiangular linear fitting. The horizontal axis represents the coordinate in the image, and the vertical axis represents an SAD value in the coordinate, in FIG. 10. As shown in FIG. 10, a position where the lines intersect with each other at the time of connecting SAD values at three points of (x−1, y), (x, y), and (x+1, y) by using equally inclined lines is obtained by the equation (2). Note that, when an SSD value is used as the difference of the pixel value pattern, a motion vector is preferably calculated by using the following equation (3) with a method that is called as parabola fitting.

$${x}_{sub} = \frac{SAD ( x - 1 , y ) - SAD ( x + 1 , y )}{2 SAD ( x - 1 , y ) - 4 SAD ( x , y ) + 2 SAD ( x + 1 , y )} \qquad ( 3 )$$

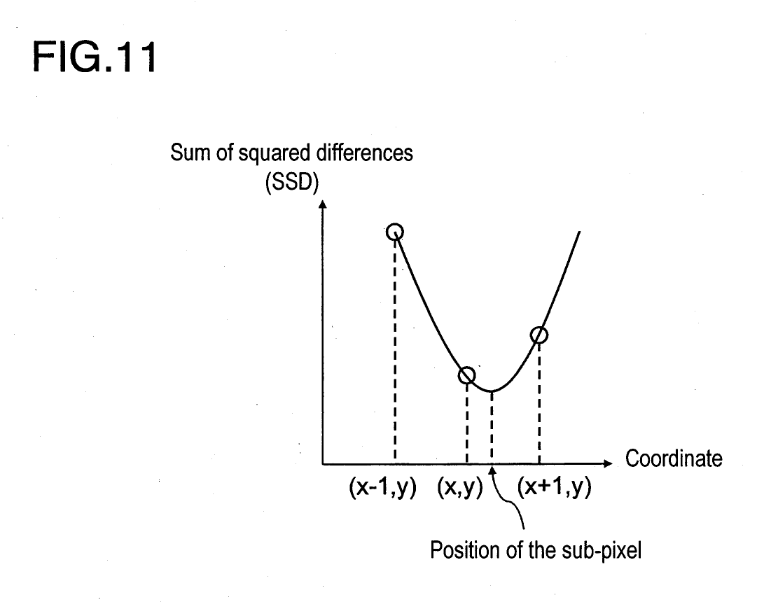

FIG. 11 is a figure explaining how the sub pixel estimation is performed by using the parabola fitting.

Next, a motion vector y_{sub} with the sub-pixel accuracy is obtained also in the vertical direction of the image in the same manner. With the processes described above, the motion vector with the sub-pixel accuracy from the target pixel P to the reference frame 107 is calculated as (x+x_{sub}, y+y_{sub}). Note that, the motion vector may be calculated for each target pixel, or may be calculated for each small region (block, in this case) of a frame to be processed collectively. For example, the frame to be processed is divided into blocks, a motion vector is calculated for each block, and the motion vectors of the pixels in the block are regarded as the same. The collective calculation of the motion vector for each small region eliminates the needs for calculating motion vectors with respect to all the pixels in the frame and for storing information related to the calculated motion vectors. Therefore, total time and amount of the processes required for the processes on the device can be reduced.

A determination is made whether or not the motion vectors are calculated for all the pixels in the process frame 106 at the step S317. If there is an unprocessed pixel, the process goes back to the step S312. If the calculations for all the pixels are completed, the process progresses to the step S308.

Referring back to FIG. 3, the estimated fine texture image 110 is generated by performing motion compensation on the reference fine texture image 109 stored in the memory 102 by using the change amount at the step S308. The following process is performed on each pixel in the estimated fine texture image 110. When a motion vector from the coordinates (i, j) in the process frame 106 to the reference frame 107 is (x, y), the pixel value of the coordinates (i, j) in the estimated fine texture image 110 is set to the pixel value of the coordinates (i+x, j+y) in the reference fine texture image 109. Note that, when the motion vector with the sub-pixel accuracy is calculated at the step S307, a pixel value is calculated by interpolating the reference fine texture image 109.

At the step S309, a result frame 111 is generated by synthesizing the estimated fine texture image 110 generated at the step S308 with the process frame 106 if the first process is selected at the step S303. On the other hand, the output frame 205 is generated by synthesizing the fine texture image 204 generated at the step S304 with the input frame 203 if the second process is selected at the step S303.

The generated result frame 111 or output frame 205 is outputted at the step S310.

At the step S311, it is checked whether or not the processes for all the frames in the moving image 105 are completed. If the processes are not completed, the process moves to the step S301. If the processes are completed, the process terminates.

According to the first embodiment, the image processing device 1 generates the estimated fine texture image 110 based on the motion vector due to the reference frame 107. Then, the image processing device 1 applies the estimated fine texture image 110 for the process frame 106 in the moving image 105. This leads to improve fineness of each frame without generating a flicker.

### Description of the Second Embodiment

A second embodiment is different from the first embodiment in that two frames are referred instead of the reference frame 107. One of the two frames is a preceding frame 1205 which is before the process frame 106 on the time axis. The other of the two frames is a following frame 1206 which is after the process frame 106 on the time axis.

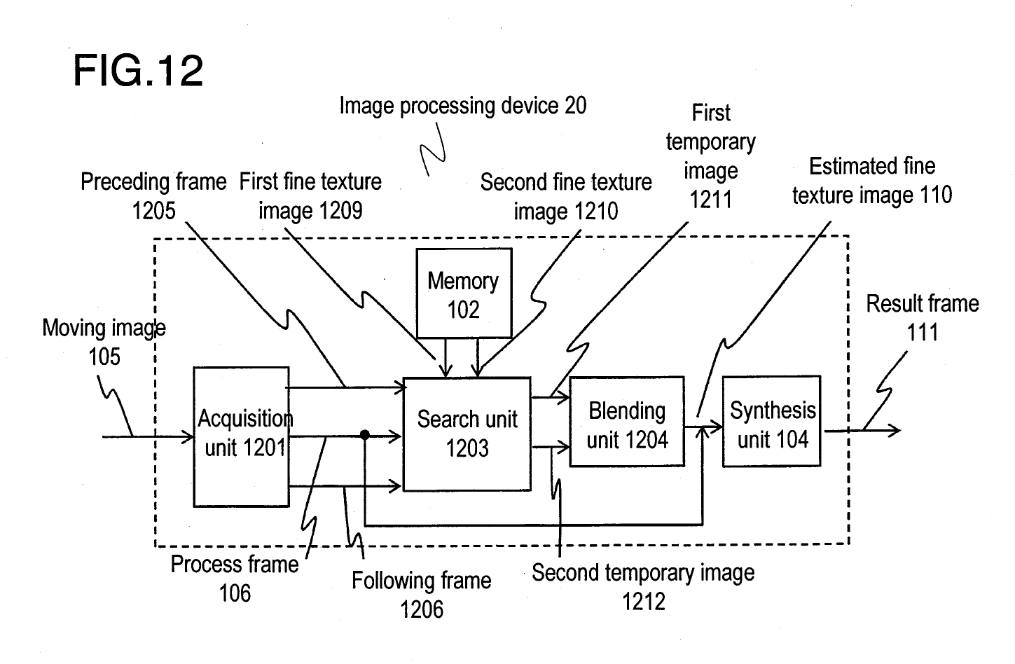

FIG. 12 is a block diagram of an image processing device 20 according to the second embodiment. An acquisition unit 1201 and a search unit 1203 of the image processing device 20 are different from them of the image processing device 1. Moreover, the image processing device 20 further includes a blending unit 1204. Note that, the same reference numerals are given to the same configuration as the first embodiment described above, and the description will be omitted.

The acquisition unit 1201 reads a frame as the process frame 106 from the moving image 105. The acquisition unit 1201 also read frames as a preceding frame 1205 and a following frame 1206 from the moving image 105. The preceding frame 1205 is present at time before the process frame 106. The following frame 1206 is present at the time after the process frame 106.

The search unit 1203 estimates a first change amount of between the process frame 106 and the preceding frame 1205. The search unit 1203 also estimates a second change amount of between the process frame 106 and the following frame 1206. Moreover, the search unit 1203 performs motion compensation on a first fine texture image 1209 stored in the memory 102 by using the first change amount, to generate a first temporary image 1211. Similarly, the search unit 1203 performs motion compensation on a second fine texture image 1210 stored in the memory 102 by using the second change amount, to generate a second temporary image 1212. The first fine texture image 1209 is a fine texture component that is generated from the preceding frame 1205 in the generation unit 201. The second fine texture image 1210 is a fine texture component that is generated from the following frame 1206 in the generation unit 201.

The blending unit 1204 synthesizes the first temporary image 1211 with the second temporary image 1212 by using an alpha blend, to generate an estimated fine texture image 110.

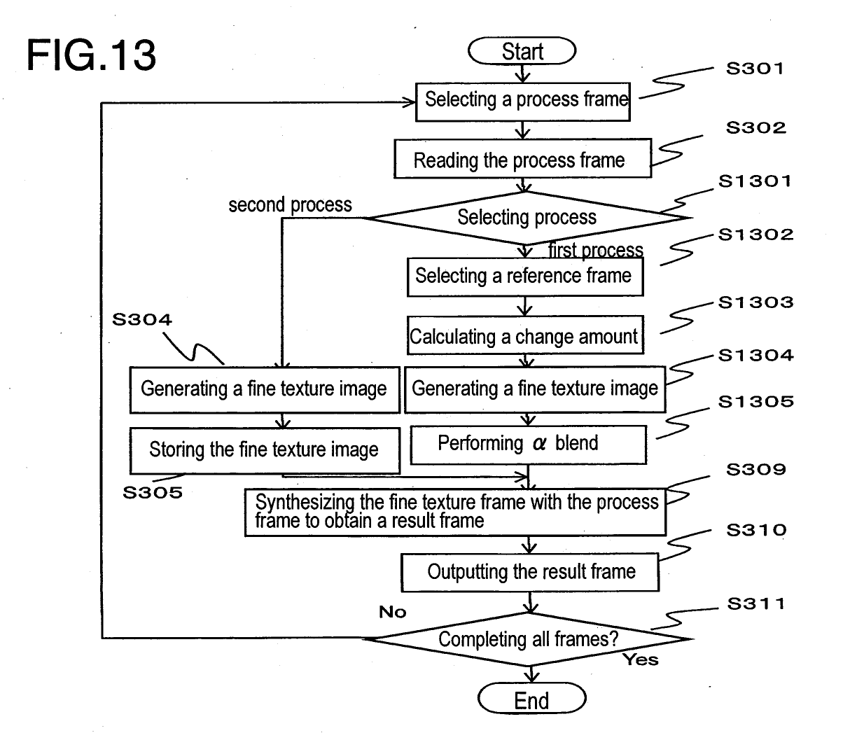

FIG. 13 is a flow chart explaining operation of the image processing device 20. The explanation of the steps S301, S302, S304, S305, and S309 to S311 is overlapped with that in FIG. 3, and therefore is omitted.

At the step S1301, a first process or a second process is selected to be applied for the process frame 106. The first process is performed by the image processing device 20. The second process is performed by the image processing device 2. When a first fine texture image 1209 and a second fine texture image 1210 are is already stored in the memory 102, the first process is selected. Each of the first fine texture image 1209 and the second fine texture image 1210 is generated from each of the frames at the time before and after the process frame 106, respectively. However, if there is a long time between the frames at the time before and after the process frame 106, the image processing device 2 may be selected. Alternatively, a variable N that determines a cycle is set, and the image processing device 2 is selected in every kN-th (k is a natural number) frame, while the image processing device 20 may be selected in the other frames. In this case, all of the kN-th frames may be processed in advance.

At the step S1302, the preceding frame 1205 and the following frame 1206 are selected, if the first process is selected at the step S1301. Among the generation source frames of the fine texture images stored in the memory 102, the preceding frame 1205 is selected from frames at the time before the process frame 106, and the following frame 1206 is selected from frames at the time after the process frame 106.

At the step S1303, the first change amount that is the amount of change from the process frame 106 to the preceding frame 1205 is calculated. Also, the second change amount that is the amount of change from the process frame 106 to the following frame 1206 is calculated. The method of calculating the change amounts is the same as that in FIG. 9.

At the step S1304, the first change amount and the second change amount that are stored in the memory 102 are read, the first temporary image 1211 is generated from the first fine texture image 1209 and the first change amount. Also, the second temporary image 1212 is generated from the second fine texture image 1210 stored in the memory 102 and the second change amount. The first fine texture image 1209 is a fine texture component that is generated from the preceding frame 1205 in the generation unit 201. The second fine texture image 1210 is a fine texture component that is generated from the following frame 1206 in the generation unit 201. The method of generating the fine texture images is the same as that at the step S308.

At the step S1305, the first temporary image 1211 and the second temporary image 1212 are synthesized with each other by using the alpha blend, to generate the estimated fine texture image 110. An equation (4) represents an equation to calculate a pixel value “valueC” by performing an alpha blend on a pixel value “valueA” and a pixel value “valueB”. The pixel value “valueC” is a pixel value of coordinates (i, j) in an image C that is a process frame. The pixel value “valueA” is a pixel value of coordinates (i, j) in an image A that is a preceding frame. The pixel value “valueB” is a pixel value of coordinates (i, j) in an image B that is a following frame.

valueC=valueA×(1−α)+valueB×α (4)

A value of α is not less than 0 but not more than 1.0, and is a weight when a certain scale is used. For example, when a time difference between the frames is used as a scale, the more time difference has the smaller value. In other words, when the time difference between the image B and the image C is longer than the time difference between the image A and the image C, a takes on a value of less than 0.5. Alternatively, when a reliability of estimation accuracy of the motion vector is used as a scale, the higher reliability has the larger value. Furthermore, when the image quality reliability is different between the following frame and the preceding frame, such as an I picture, a P picture, and a B picture, the higher the image quality reliability is, the larger the value is. Note that α may be determined with respect to the whole screen, or may be changed for each pixel.

Furthermore, the motion vector that is calculated in the search unit based on the first change amount and the second change amount may be used. In this case, in accordance with the Euclid distance in vector between the pixel and a corresponding point in the reference frame, the longer distance has the smaller value.

According to the second embodiment, the image processing device 20 estimates a motion vector from the frames before and after the process frame 106. The image processing device 20 also generates the estimated fine texture image 110 based on the weighted sum using a distance as a weight. Accordingly, effects of flicker prevention with higher accuracy can be expected.

### (Modified Example)

The equal scale-up process in which an input moving image size is identical with an output moving image size has mainly described in the first embodiment and the second embodiment. However, it is not limited to the equally scale-up process, and is applicable to a case where an input moving image size is different from an output moving image size. In the modified example, a scale-up process for a case where the output moving image size is larger than the input moving image size will be described. Note that the same reference numerals are given to the same configuration as the embodiments described above, and the description will be omitted.

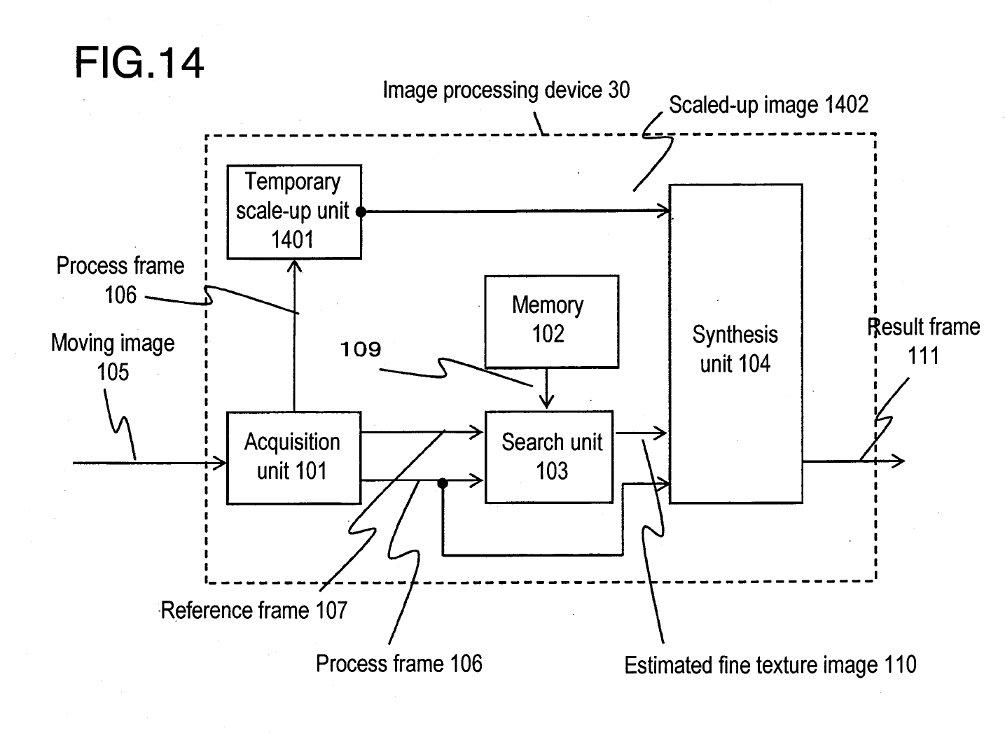

FIG. 14 is a block diagram of an image processing device 30 according to the modified example. The image processing device 30 is different from the image processing device 1 of FIG. 1 in that a temporary scale-up unit 1401 is further included.

The acquisition unit 101 sets images as the process frame 106 and the reference frame 107 from the inputted moving image 105. Then, the acquisition unit 101 transmits the process frame 106 to the temporary scale-up unit 1401.

The temporary scale-up unit 1401 scales up the process frame 106 to generate a scaled-up image 1402.

The synthesis unit 104 synthesizes a estimated fine texture image 110 with a scaled-up image 1402, and outputs a result frame 111.

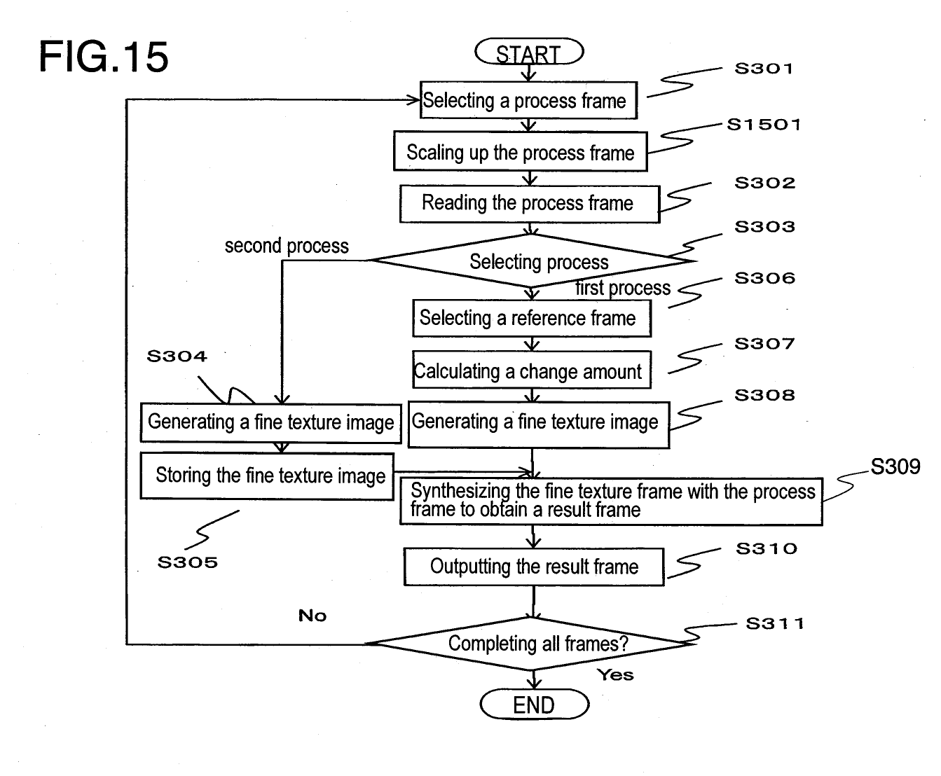

FIG. 15 is a flow chart explaining operation of the image processing device 30.

At the step S301, a process frame 106 is selected from the moving image 105. The process frame 106 may be any one of unprocessed frames in the moving image 105.

A scaled-up image 1402 in which the process frame 106 is scaled up is generated at the step S1501. Any image scale-up method can be used as a method of scaling up an image. For example, a method of scaling up an image by interpolating pixel values may be used, such as a nearest neighbor method, a linear interpolation method, and a cubic convolution method (bi-cubic interpolation method). Preferably, using the image scale-up method capable of obtaining an image having as less blur as possible is desirable in a viewpoint of prevention of image quality deterioration.

The process frame 106 is read as an image data at the step S302.

A frame identical with the temporary scaled-up image scaled up at the step S1501 may be set as the process frame 106 at the step S302.

The steps from S303 to S307 are the same as those in the first embodiment. Alternatively, the scaled-up image 1402 scaled up in the temporary scale-up unit 1401 can be set as the process frame 106, or the reference frame 107 can be selected among the images scaled up in the temporary scale-up unit 1401.

An estimated fine texture image 110 is generated at the step S308 by performing motion compensation on the reference fine texture image 109 stored in the memory 102 by using the change amount. When a scaled-up image having a larger number of the pixels than those of the input image is used as an output image as the synthesized result, the fine texture image generated from the temporary scaled-up image of the texture image, the fine texture image generated from the process frame, or the fine texture image generated by scaling down the process frame may be used.

Note that, when having a smaller size than the size of a frame as the synthesized result, an image from which a texture component is extracted has a higher frequency than that of the texture of the process frame size. This improves the fineness in the image quality. For example, some methods as in the case in the first embodiment improve the fineness of the texture in the image. The methods include a method of generating a texture image by scaling down the image, of generating a texture image from a frame as an object to be processed to synthesize the texture image with a scaled-up image having the larger number of the pixels, and of generating a texture image by scaling up an image to synthesize the texture image with a scaled-up image.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

The abovementioned image processing devices in the embodiments can be achieved by using a general-purpose computer device as basic hardware, for example. A program to be executed has a module configuration including the above-mentioned functions. The program may be provided by being recorded on computer-readable recording media such as a CD-ROM, a CD-R or a DVD, in a file having a format in which the program is installable or executable, or being incorporated into a ROM or the like in advance.

What is claimed is:

1. An image processing apparatus, comprising:
an acquisition unit to acquire a moving image including a plurality of images, and to set a pixel in a process image as a target pixel, the process image being to be processed in the moving image;
a memory to store a fine texture image obtained by extracting a texture component in a reference image different from the process image;
a search unit to set a pixel position of the target pixel as a first position, and to search a predetermined range in the fine texture image in order to find a second position corresponding to the first position; and
a synthesis unit to synthesize a pixel value of the second position in the fine texture image with a pixel value of the target pixel.

2. The apparatus of claim 1, wherein
the acquisition unit selects a preceding image and a following image as reference images, the preceding image being preceding the process image, the following image being following the process image,
the search unit searches the preceding image for a third position corresponding to the first position and the following image for a fourth position corresponding to the first position, and
the synthesis unit synthesizes a pixel value of the third position and a pixel value of the fourth position with the pixel value of the target pixel.

3. The apparatus of claim 2, wherein
the synthesis unit includes a controller to assign weights to the pixel value of the third position and to the pixel value of the fourth position, and
when a time difference between the process image and the following image is large, the controller assigns a small weight according to the time difference to the pixel value of the third position, and
when the time difference is small, the controller assigns a large weight according to the time difference to the pixel value of the fourth position.

4. The apparatus of claim 1, further comprising:
a texture extraction unit to generate the texture component in the reference image as a texture image; and
a fine texture generator to generate a fine texture image, by searching a similar pixel and assigning a pixel value of the similar pixel to the pixel value of the target pixel, the similar pixel being surrounded by pixels having a change pattern which is a similar to the change pattern of the pixels included in the texture image, the similar pixel being searched within a search range in the texture image, the search range including a position in the texture image corresponding to the position of the target pixel,
wherein the memory stores the fine texture image.

5. The apparatus of claim 4, wherein the texture extraction unit generates the texture image from a scaled-down image of the process image.

6. The apparatus of claim 4, wherein the generation unit generates the texture image from a same-scaled image or a scaled-up image of the process image.

7. The apparatus of claim 5, further comprising a temporary scale-up unit to generate a scaled-up image having a larger number of pixels than the process image, wherein
the acquisition unit sets the scaled-up image as the process image.

8. The apparatus of claim 5, wherein an image after the synthesis is an image having the same number of pixels as the number of the pixels to be processed.

9. The apparatus of claim 1, further comprising a display unit to display the synthesized result.
